(19) United States
(12) Patent Application Publication
(10) Pub. No.: US 2026/0046900 A1
(43) Pub. Date: Feb. 12, 2026

(54) CHANNEL OCCUPANCY SHARING FOR SIDELINK FEEDBACK CHANNEL TRANSMISSIONS

(71) Applicant: LENOVO (SINGAPORE) PTE. LTD., Singapore (SG)

(72) Inventors: Joachim LOHR, Wiesbaden (DE); Alexander Johann Maria Golitschek Edler Von Elbwart, Darmstadt (DE); Karthikeyan GANESAN, Nauheim (DE); Prateek BASU MALLICK, Dreieich (DE)

(21) Appl. No.: 19/102,282

(22) PCT Filed: Aug. 10, 2023
(86) PCT No.: PCT/IB2023/058079

§ 371 Date: Feb. 7, 2025

Related U.S. Application Data
(60) Provisional application No. 63/396,835, filed on Aug. 10, 2022.

(51) Int. Cl. H04W 72/25; H04L 1/1812; H04W 56/00; H04W 74/0816

(52) U.S. Cl. CPC H04W 72/25; H04L 1/1812; H04W 56/0015; H04W 74/0816

(57) ABSTRACT

Various aspects of the present disclosure relate to receiving sidelink control information (SCI) allocating resources for a physical sidelink shared channel (PSSCH) transmission, the SCI including a field indicating a channel occupancy time (COT) duration of a first COT, and transmitting hybrid automatic repeat request (HARQ) feedback in a physical sidelink feedback channel (PSFCH) transmission within the COT duration without initiating another COT based on the SCI. A receiving UE may determine the COT duration indicated by the SCI as shared for the transmission of the HARQ feedback on the PSFCH.

### TECHNICAL FIELD

The present disclosure relates to wireless communications, and more specifically to sharing channel occupancy time in unlicensed spectrum.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Network nodes that operate in unlicensed spectrum may be required to perform a Clear Channel Assessment (CCA) such as by Listen Before Talk (LBT), also referred to as channel sensing, prior to being able to transmit in the unlicensed spectrum. If the network node performing LBT does not detect the presence of other signals in the channel, the channel is considered available for transmission.

In a Frame Based Equipment (FBE) mode of operation, the network node performs LBT in an idle period, e.g. at the end of each idle period. After acquiring the channel, the network node can communicate within the non-idle time of a fixed frame period duration, referred to as Channel Occupancy Time (COT). The LBT process occupies time and processing resources.

### SUMMARY

The present disclosure relates to methods, apparatuses, and systems that support sharing channel occupancy time (COT) for Physical Sidelink Feedback Channel (PSFCH) transmissions.

Some implementations of the method and apparatuses described herein may further include receiving sidelink control information (SCI) allocating resources for a physical sidelink shared channel (PSSCH) transmission, the SCI including a field indicating a channel occupancy time (COT) duration of a first COT, and transmitting hybrid automatic repeat request (HARQ) feedback in a physical sidelink feedback channel (PSFCH) transmission within the COT duration without initiating another COT based on the SCI.

In some implementations of the method and apparatuses described herein, the COT duration is extracted from the SCI, and a UE transmits the HARQ feedback without initiating another COT when the PSFCH transmission falls within the COT duration extracted from the SCI.

In some implementations of the method and apparatuses described herein the COT duration indicated by the SCI is determined as being shared for the transmission of the HARQ feedback on the PSFCH.

In some implementations of the method and apparatuses described herein, a UE determines whether to initiate another COT before transmitting the HARQ feedback based on an information field within the SCI. In an embodiment, the information field indicates whether HARQ is enabled for the PSSCH transmission.

In some implementations of the method and apparatuses described herein, a UE determines not to initiate another COT before transmitting the HARQ feedback after confirming that 1) the SCI indicates that HARQ is enabled for the PSSCH transmission, and 2) the PSFCH transmission is within the COT duration indicated by the SCI.

In some implementations of the method and apparatuses described herein, the SCI includes an indication that indicates whether to use a cyclic prefix extension in conjunction with transmitting the HARQ feedback, and the method includes transmitting the cyclic prefix extension, wherein cyclic prefix extension reduces the duration of a guard interval in the same resource pool in which the HARQ feedback is transmitted.

In some implementations of the method and apparatuses described herein, the SCI includes an indication that indicates whether to perform a listen before talk procedure before transmitting the HARQ feedback.

In some implementations of the method and apparatuses described herein, an identical copy of at least a first portion of the PSFCH transmission is transmitted immediately after transmitting the HARQ feedback on the PSFCH.

In some implementations of the method and apparatuses described herein, the only transmissions permitted during the COT indicated by the SCI comprise the HARQ feedback and a repeat of the HARQ feedback.

Some implementations of the method and apparatuses described herein may further include a user equipment (UE) for wireless communication, including at least one memory, and at least one processor coupled with the at least one memory and configured to cause the UE to receive SCI allocating resources for a PSSCH transmission, the SCI including a field indicating a COT duration, and transmit HARQ feedback within the COT duration in a PSFCH transmission without initiating another COT based on the SCI.

Some implementations of the method and apparatuses described herein may further include a processor for wireless communication with at least one memory, and a controller coupled with the at least one memory and configured to cause the controller to receive SCI allocating resources for a PSSCH transmission, the SCI including a field indicating a COT duration, and transmit HARQ feedback within the COT duration in a PSFCH transmission without initiating another COT based on the SCI.

### BRIEF DESCRIPTION OF THE DRAWINGS

FIG. 1 illustrates an example of a wireless communications system that supports channel occupancy sharing for sidelink transmissions in accordance with aspects of the present disclosure.

FIG. 2 illustrates an example of a system that supports channel occupancy sharing for sidelink transmissions in accordance with aspects of the present disclosure.

FIG. 3 illustrates an example of a block diagram of a device that supports channel occupancy sharing for sidelink transmissions in accordance with aspects of the present disclosure.

FIGS. 4 through 6 illustrate examples of slots for sidelink communications.

FIG. 7 is a flowchart of a method that supports channel occupancy sharing for sidelink transmissions in accordance with aspects of the present disclosure.

FIG. 8 illustrates an example of a block diagram of a processor that supports channel occupancy sharing for sidelink feedback channel transmissions in accordance with aspects of the present disclosure.

### DETAILED DESCRIPTION

For operation in unlicensed spectrum, especially in a semi-static channel access (operation according to Frame-Based Equipment), downlink and uplink transmissions are allowed after a node such as a gNB or a UE has acquired a shared channel by a successful clear channel assessment (CCA), following a listen-before-talk (LBT) procedure. The procedures for gNBs and UEs acquiring a channel occupancy time (COT) have been specified for both dynamic and semi-static channel access.

In conventional cellular topology with a centralized scheduler, a gNB can initiate a COT and may share this COT with one or more UEs, or a UE can initiate a COT and share this COT with a gNB. The sharing of a COT is indicated by a specific field in downlink control information or uplink control information.

For operation in unlicensed spectrum, sidelink transmissions are allowed after a node such as a UE has acquired the shared channel by a successful clear channel assessment (CCA), following a listen-before-talk (LBT) procedure. In a sidelink environment, a UE may have sidelink connections to and from multiple UEs using a Hybrid Automatic Repeat Request (HARQ) protocol. A UE may send HARQ feedback information on the Physical Sidelink Feedback Channel (PSFCH) for a sidelink transmission, especially a Physical Sidelink Shared Channel (PSSCH) transmission.

When a receiving UE initiates its own COT for a PSFCH transmission, it is not always ensured that HARQ feedback is transmitted at the allocated timing. For example, an LBT process may not be successful. This will ultimately increase the delay of a sidelink transmission and impact its reliability.

Since COT sharing provides a shorter or no required channel sensing time for a clear channel assessment, it is beneficial for a UE to exploit COT sharing for the transmission of HARQ feedback for a PSSCH transmission. This disclosure presents solutions for a UE to avoid initiating its own COT for the transmission of HARQ feedback on the PSFCH. Instead, the COT acquired by the UE for the corresponding PSSCH transmission is shared for the PSFCH transmission.

According to one embodiment, a receiving UE considers a COT acquired by a transmitting UE for a PSSCH transmission as being shared for the transmission of the corresponding HARQ feedback on the PSFCH. For cases when PSFCH symbol(s) in the resource pool are overlapping with the COT acquired by the transmitting UE, which sent a PSSCH transmission to the receiving UE, the receiving UE assumes that the transmitting UE shared the COT with the receiving UE for the transmission of the corresponding PSFCH transmission.

According to an embodiment, sidelink control information (SCI) comprises two new fields which indicate whether the COT is shared to the receiving UE for the transmission of the PSFCH corresponding to the PSSCH associated with the SCI and whether the receiving should use Cyclic Prefix (CP) extension in order to shorten a gap before a PSFCH symbol, e.g., a gap between a PSSCH symbol and an automatic gain control (AGC) symbol before the PSFCH.

Since COT sharing allows a shorter or no required channel sensing time for a clear channel assessment, there is a benefit for a UE to exploit COT sharing for the transmission of HARQ feedback for a PSSCH transmission. Benefits of embodiments of the present disclosure include improved reliability and a more efficient use of time and processing resources.

Aspects of the present disclosure are described in the context of a wireless communications system. Aspects of the present disclosure are further illustrated and described with reference to device diagrams and flowcharts.

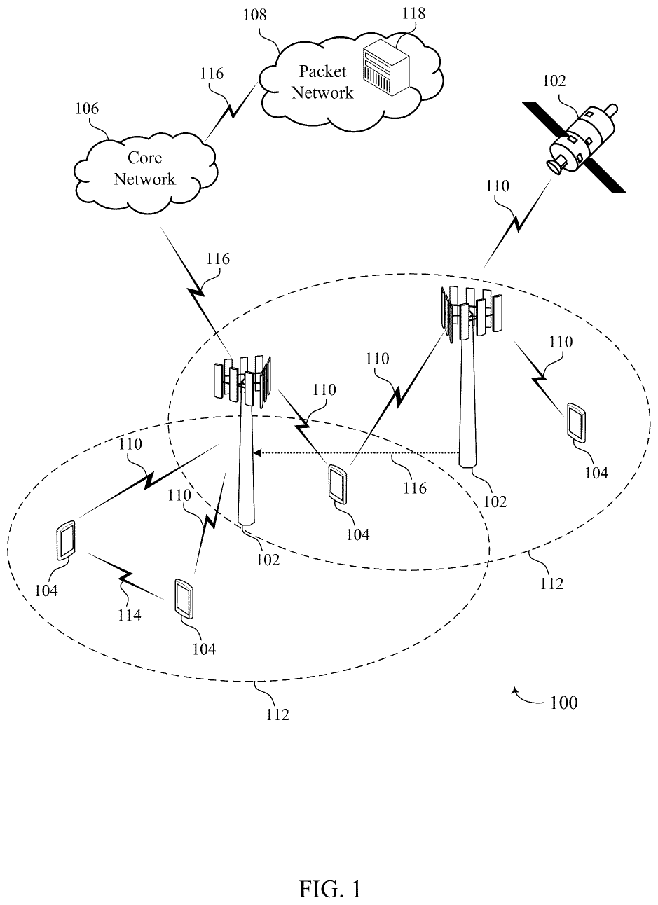

FIG. 1 illustrates an example of a wireless communications system 100 that supports channel occupancy sharing for sidelink feedback channel transmissions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHz), FR4a or FR4-1 (52.6 GHZ-71 GHZ), and FR5 (114.25 GHz-300 GHz). In some implementations, the network entities 102 and the UEs 104 may perform wireless communications over one or more of the operating frequency bands. In some implementations, FRI may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

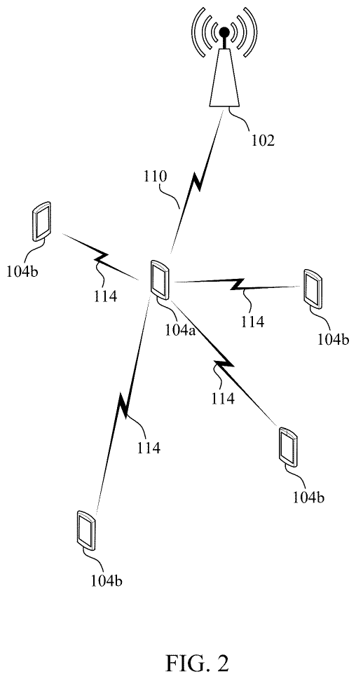

FIG. 2 illustrates an example of a system that supports channel occupancy sharing for sidelink feedback channel transmissions in accordance with aspects of the present disclosure.

Embodiments of the present disclosure relate to sidelink communications between UEs 104 using unlicensed spectrum. The sidelink communications may be facilitated by a base station node 102 such as a gNB. For example, a base station 102 and a transmitting UE 104a may communicate with each other over communication link 110, and each receiving UE 104b may communicate with the base station 102 over respective communication links 110. In addition, the transmitting UE 104a may communicate with nearby receiving UEs 104b using sidelink communications 114.

In one example, the base station 102 is a gNB that provides data to transmitting UE 104a, which in turn broadcasts that data to multiple receiving UEs 104b in unlicensed spectrum. This may be helpful, for example, when licensed spectrum is highly occupied, or other cases where unlicensed spectrum is a viable or superior alternative to licensed spectrum.

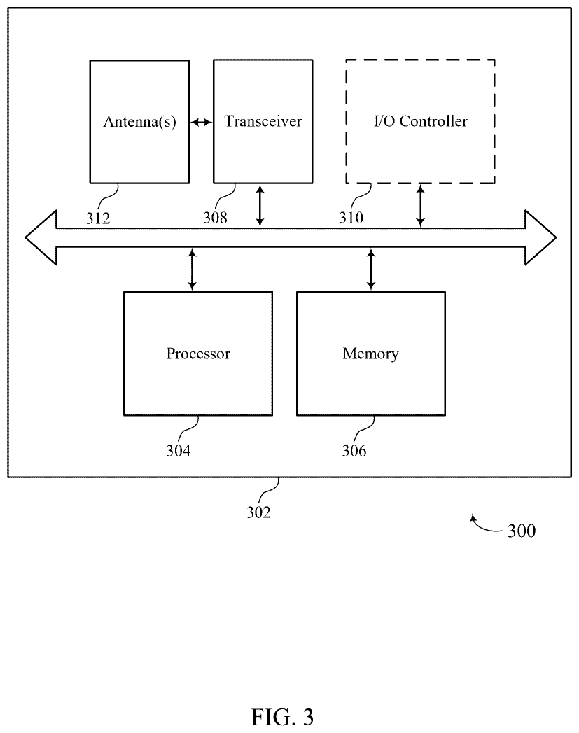

FIG. 3 illustrates an example of a block diagram 300 of a device 302 that supports channel occupancy sharing for sidelink transmissions in accordance with aspects of the present disclosure. The device 302 may be an example of a UE 104 as described herein. The device 302 may support wireless communication with one or more network entities 102, UEs 104, or any combination thereof. The device 302 may include components for bi-directional communications including components for transmitting and receiving communications, such as a processor 304, a memory 306, a transceiver 308, and an I/O controller 310. These components may be in electronic communication or otherwise coupled (e.g., operatively, communicatively, functionally, electronically, electrically) via one or more interfaces (e.g., buses).

The processor 304, the memory 306, the transceiver 308, or various combinations thereof or various components thereof may be examples of means for performing various aspects of the present disclosure as described herein. For example, the processor 304, the memory 306, the transceiver 308, or various combinations or components thereof may support a method for performing one or more of the operations described herein.

In some implementations, the processor 304, the memory 306, the transceiver 308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 304 and the memory 306 coupled with the processor 304 may be configured to perform one or more of the functions described herein (e.g., executing, by the processor 304, instructions stored in the memory 306).

For example, the processor 304 may support wireless communication at the device 302 in accordance with examples as disclosed herein. Processor 304 may be configured as or otherwise support channel occupancy sharing for sidelink feedback channel transmissions.

The processor 304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 304 may be configured to operate a memory array using a memory controller. In some other implementations, a memory controller may be integrated into the processor 304. The processor 304 may be configured to execute computer-readable instructions stored in a memory (e.g., the memory 306) to cause the device 302 to perform various functions of the present disclosure.

The memory 306 may include random access memory (RAM) and read-only memory (ROM). The memory 306 may store computer-readable, computer-executable code including instructions that, when executed by the processor 304 cause the device 302 to perform various functions described herein. The code may be stored in a non-transitory computer-readable medium such as system memory or another type of memory. In some implementations, the code may not be directly executable by the processor 304 but may cause a computer (e.g., when compiled and executed) to perform functions described herein. In some implementations, the memory 306 may include, among other things, a basic I/O system (BIOS) which may control basic hardware or software operation such as the interaction with peripheral components or devices.

The I/O controller 310 may manage input and output signals for the device 302. The I/O controller 310 may also manage peripherals not integrated into the device M02. In some implementations, the I/O controller 310 may represent a physical connection or port to an external peripheral. In some implementations, the I/O controller 310 may utilize an operating system such as iOS®, ANDROID®, MS-DOS®, MS-WINDOWS®, OS/2®, UNIX®, LINUX®, or another known operating system. In some implementations, the I/O controller 310 may be implemented as part of a processor, such as the processor M06. In some implementations, a user may interact with the device 302 via the I/O controller 310 or via hardware components controlled by the I/O controller 310.

In some implementations, the device 302 may include a single antenna 312. However, in some other implementations, the device 302 may have more than one antenna 312 (i.e., multiple antennas), including multiple antenna panels or antenna arrays, which may be capable of concurrently transmitting or receiving multiple wireless transmissions. The transceiver 308 may communicate bi-directionally, via the one or more antennas 312, wired, or wireless links as described herein. For example, the transceiver 308 may represent a wireless transceiver and may communicate bi-directionally with another wireless transceiver. The transceiver 308 may also include a modem to modulate the packets, to provide the modulated packets to one or more antennas 312 for transmission, and to demodulate packets received from the one or more antennas 312.

For operation in unlicensed spectrum, especially in a semi-static channel access (operation according to Frame-Based Equipment (FBE)), downlink and uplink transmissions are allowed after a node such as a gNB or a UE has acquired the shared channel by a successful clear channel assessment (CCA), following a listen-before-talk (LBT) procedure. If the device/network node performing LBT does not detect the presence of other signals in the channel, the channel is considered available for transmission.

In FBE mode, the network node performs LBT in an idle period and after acquiring the channel, the network node can communicate within the non-idle time of a fixed frame period duration referred to as channel occupancy time (COT). In current specifications and regulations, the idle time is not shorter than the maximum of 5% of the FFP and 100 microseconds. Procedures for gNBs and UEs acquiring a channel occupancy time (COT) are available for both dynamic and semi-static channel access.

Determining ownership of a COT, or determining which device has initiated the COT for an UL transmission, may be performed at both a gNB and a UE to determine 1) whether another UE can send another UL transmission within the COT, 2) which idle period (gNB's or UE's) should be respected (e.g., an UL transmission is not allowed within the respected idle period), and 3) an energy detect (ED) threshold. An ED threshold might be different, for example, when a gNB shares a UE-COT or UE-initiated COT or might be different if the ED threshold is determined based on UE transmit power, and/or gNB transmit power.

In a sidelink environment, a UE may have sidelink connections to and from multiple UEs using HARQ, in which case a UE may send HARQ feedback information on the PSFCH for a sidelink transmission (PSSCH). Since COT sharing allows a shorter or no required channel sensing time for a clear channel assessment, there is a benefit for a UE to exploit COT sharing for the transmission of HARQ feedback for a PSSCH transmission. At present, COT sharing is not supported on sidelink unlicensed carriers.

The present disclosure presents solutions for a UE to avoid initiating its own COT for the transmission of HARQ feedback on the PSFCH.

After a transmitting UE has initiated a COT for sidelink communications in unlicensed spectrum, the transmitting UE may use physical sidelink control channel (PSCCH) and PSSCH resources in the occupied channel. In NR, available sidelink resources include slots allocated for sidelink (time resources) and common RBs within a sidelink bandwidth part (BWP) (frequency resources). A subset of the available sidelink resources is configured to be used by several UEs for their sidelink transmissions. This subset of available sidelink resources is referred to as a resource pool (RP). The common resource blocks within a resource pool are referred to as physical resource blocks (PRBs). A resource pool may consist of contiguous PRBs and contiguous or non-contiguous slots that are configured for sidelink transmissions.

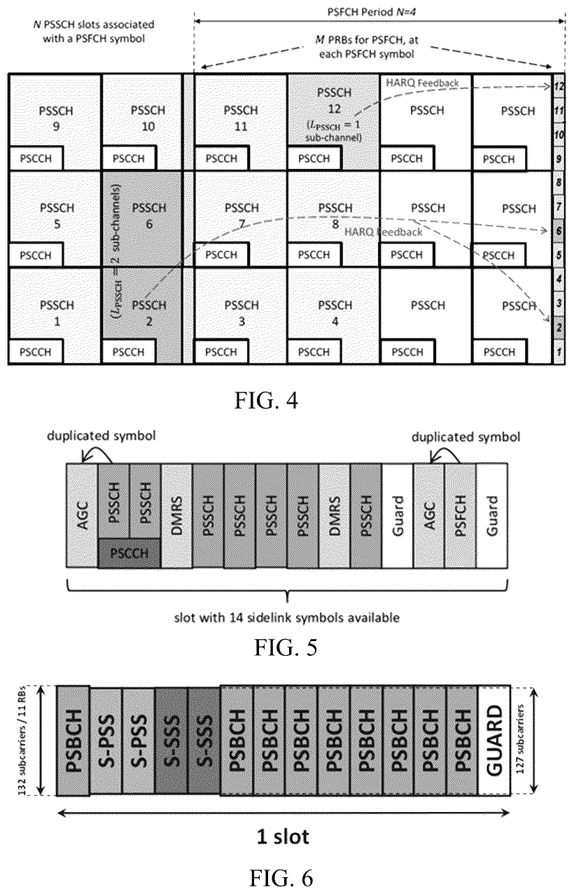

FIG. 4 illustrates an embodiment of PSSCH slots in sidelink that are associated with PSFCH symbols. In the embodiment of FIG. 4, the final set of slots in the time domain include a PSFCH in which HARQ feedback for previous PSSCHs can be provided to the transmitting UE.

With L sub-channels in a resource pool and N PSSCH slots associated with a slot containing PSFCH, N·L sub-channels are associated with a PSFCH symbol. With M PRBs available for PSFCH in a PSFCH symbol, there are M PRBs available for HARQ feedback of transmissions over N·L sub-channels. With M configured to be a multiple of N·L, then a distinct set of PRBs can be associated with the HARQ feedback for each sub-channel within a PSFCH period.

The first set of PRBs among the M PRBs available for PSFCH are associated with the HARQ feedback of a transmission in the first sub-channel in the first slot. The second set of PRBs are associated with the HARQ feedback of a transmission in the first sub-channel in the second slot, etc. This is illustrated in FIG. 4 with N=4, L=3, and all PRBs in a PSFCH symbol available for PSFCH. In this example, the HARQ feedback for a transmission at PSSCH x is sent on PRBs in the corresponding PSFCH symbol, with x=1, . . . , 12.

For a transmission in a PSSCH with LPSSCH>1 sub-channels, LPSSCH·Mset PRBs could be available for the HARQ feedback of this transmission. For example, FIG. 4 illustrates a transmission over the first and second sub-channel in the second slot (LPSSCH=2). There are then two sets of PRBs in the first and second sub-channel of the PSFCH symbol that could be available for the HARQ feedback of this transmission.

FIG. 5 illustrates an embodiment of a sidelink (PSCCH/PSSCH) slot with a PFSCH symbol. A PSFCH in the Slot of FIG. 5 carries HARQ feedback from receiving UEs to a transmitting UE. Within a resource pool, resources for PSFCH can be configured periodically with a period of 1, 2 or 4 slot(s) so that there is a slot with PSFCH every 1, 2 or 4 slot(s) within a resource pool. The PSFCH may be sent in one symbol among the last sidelink symbols in a PSCCH/PSSCH slot as shown in the example in FIG. 5. Prior to the PSFCH symbol, one AGC symbol is used, which may be a copy of the PSFCH symbol. The symbol after the PSFCH symbol can be used as a guard symbol as shown in the figure.

In a resource pool, the set of PRBs in a PSFCH symbol that are available for PSFCH may be indicated using a bitmap. For a transmission of PSFCH, one PRB in a PSFCH symbol may be used that carries a Zadoff-Chu sequence based on the sequences used for the physical uplink control channel (PUCCH) in Uu.

According to an embodiment of the present disclosure, a UE 104 considers a COT acquired by a transmitting UE 104a as being shared for the transmission of HARQ feedback on the PSFCH. For cases in which one or more PSFCH symbol in a resource pool overlap with the COT acquired by the transmitting UE 104a, which sent a PSSCH transmission to the receiving UE 104b, the receiving UE 104b determines that the transmitting UE 104a shared the COT with the receiving UE 104b for at least or only the transmission of the corresponding PSFCH. The transmitting UE 104a may indicate information on the acquired COT, e.g. remaining COT duration, channel access priority class (CAPC) used for initiating the COT, etc. This information may be indicated within the SCI sent along with PSSCH, to the receiving UE 104b.

Since COT sharing provides a shorter or no required channel sensing time for a clear channel assessment, there is a benefit for a receiving UE 104b to consider the COT as shared for the PSFCH transmission. According to one implementation, the shared COT is only valid for the PSFCH transmission, such that no further sidelink transmissions from the receiving UE 104b are allowed within the shared COT. In one embodiment, after the PSFCH transmission, the right to use the remaining COT is implicitly given back to the transmitting UE 104a which had originally initiated the COT, such that the receiving UE 104b implicitly shares the remaining COT with the transmitting UE 104a.

In an embodiment, the receiving UE 104b uses CP extension to shorten or fill a gap before the PSFCH symbol. The gap may be a gap between a PSSCH symbol and an AGC symbol before the PSFCH, e.g. the guard symbol indicated in FIG. 5. Shortening the gap may obviate the need to perform LBT for the PSFCH transmission in the shared COT. Leaving a one symbol gap before the PSFCH/AGC symbols may cause the UE to lose the channel. The length of the CP extension used to fill the gap may be a single symbol with a duration of 16 μs.

These and other embodiments will now be explained in more detail with respect to method 700.

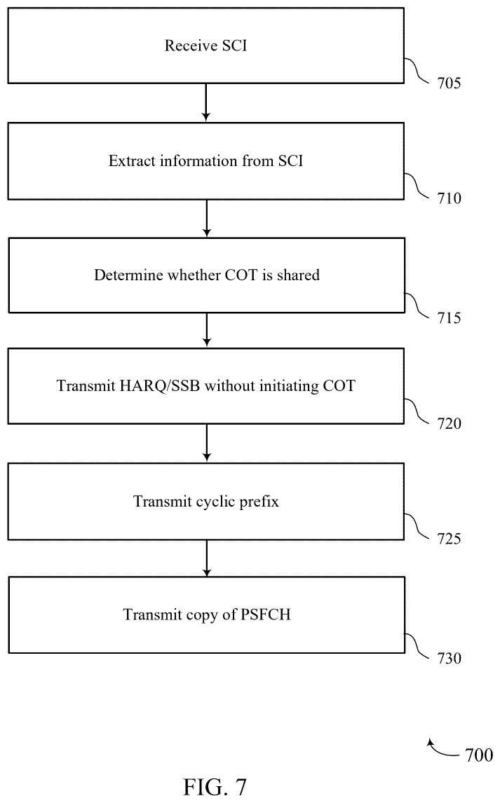

FIG. 7 illustrates a flowchart of a method 700 that supports channel occupancy sharing for sidelink transmissions in accordance with aspects of the present disclosure. The operations of the method 700 may be implemented by a device or its components as described herein. For example, the operations of the method 700 may be performed by a UE 104 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 705, the method may include receiving sidelink control information (SCI). The operations of 705 may be performed in accordance with examples as described herein. In some implementations, aspects of the operations of 705 may be performed by a device as described with reference to FIG. 1.

An SCI may be used for notifying the slot format, COT duration, available RB set, and search space set group switching within the COT. For example, an SCI may transmit one or more of a set of slot format indicators, an available set of resource blocks, a COT duration, an identity of the entity to which the COT belongs, etc. In an embodiment, the SCI includes one or more indication that indicates whether the COT is shared for the purpose of transmitting HARQ feedback on the PSFCH.

In an embodiment in which a transmitting UE 104 has established a COT, the SCI received at 705 may be transmitted in a PSCCH during the COT. The SCI may be received by one or more UEs in unlicensed spectrum.

At 710, the method may include extracting information from the received SCI. The operations of 710 may be performed in accordance with examples as described herein. In some implementations, aspects of the operations of 710 may be performed by a device as described with reference to FIG. 1. Extracting information may include one or more of decoding a received SCI, storing the SCI in a memory, and processing information within the SCI.

Information that may be extracted from the received SCI at 710 includes a duration of the COT established by the transmitting UE 104a as indicated above, as well as conventional information within the SCI. In an embodiment, the receiving UE 104b extracts a new field within the SCI associated with a PSSCH transmission that indicates whether the COT is shared for the corresponding PSFCH. In particular, the field may indicate that the COT is shared to the receiving UE 104b, which may be the recipient of the PSSCH transmission, for the purpose of HARQ feedback for the PSSCH transmission.

In another embodiment, an SCI comprises two new fields which indicate whether the COT is shared to the receiving UE 104b for the transmission of the PSFCH corresponding to the PSSCH associated with the SCI, and whether the receiving UE 104b should use CP extension to shorten the gap before the PSFCH symbol, e.g. a gap between PSSCH symbol and an AGC symbol. Accordingly, a receiving UE 104b may extract a first field from the SCI that indicates whether the COT is shared for transmitting on the PSFCH, and extract a second field from the SCI that indicates whether to use CP extension to fill gaps in a sub-channel.

In an embodiment, SCI accompanying a PSSCH indicates whether LBT is to be performed by the receiving UE 104b for the corresponding PSFCH transmission, e.g. HARQ feedback for the PSSCH. In such an embodiment, the receiving UE 104b extracts the LBT indication from the SCI at 710 and either performs or does not perform LBT before transmitting HARQ feedback according to the indication value.

In an embodiment, the SCI indicates COT sharing information to a group of receiving UEs. According to one implementation, the SCI has no accompanying PSSCH, so the SCI is provided in a SCI only transmission. In one example the COT sharing information comprises a COT duration. In an embodiment, the COT sharing information indicates whether receiving UEs are to initiate their own COT for a PSFCH transmission, or whether the COT is shared for the PSFCH transmission. In one example the COT sharing information indicates whether CP extension should be used to shorten or fill the gap before PSFCH. In another example the SCI indicates within the COT sharing information whether receiving UEs 104b are to perform LBT for the PSFCH transmission. In these embodiments, receiving UEs 104b may extract any of this information from the SCI without the accompanying PSSCH.

At 715, the method may include determining whether a COT is shared. The operations of 715 may be performed in accordance with examples as described herein. In some implementations, aspects of the operations of 715 may be performed by a device as described with reference to FIG. 1.

Upon reception of an SCI, a receiving UE determines whether the transmitting UE 104a shared its COT with the receiving UE 104b for the PSFCH transmission at 715. If the receiving UE 104b determines that the transmitting UE 104a has not shared its COT, the receiving UE 104b may initiate its own COT and transmit HARQ feedback for the PSSCH on a PSFCH within that COT. Otherwise, if the receiving UE 104b determines that the COT is shared, the receiving UE 104b transmits HARQ feedback on a PSFCH within the shared COT.

In an embodiment, the receiving UE 104b is configured to determine that the COT is shared at 715 when it determines that a PSFCH is available for providing HARQ feedback within the COT duration. In another embodiment, the receiving UE 104b determines whether the COT is shared based on information extracted from the SCI at 710. For example, the receiving UE 104b may determine whether a COT initiated by a transmitting UE 104a is shared to the receiving UE 104b for transmitting in a PSFCH corresponding to a PSSCH transmission from the transmitting UE 104a based on a field within SCI accompanying the PSSCH.

According to an embodiment, the receiving UE 104b determines based on a field indicating whether HARQ is enabled, e.g. a “HARQ enabled” field, within the SCI whether the COT is assumed be shared, and therefore does not initiate its own COT for the transmission of the PSFCH. In particular, the receiving UE 104b considers the COT as being shared by the transmitting UE 104a for the PSFCH transmission when the SCI indicates that HARQ is enabled for the corresponding PSSCH transmission. Initiating a COT typically involves sensing for a predetermined amount of sensing time before transmissions are allowed, while starting a PSFCH transmission in a shared COT may involve no such sensing or only a fraction of the sensing time required for initiating a COT.

At 720, the method may include transmitting a HARQ or SSB without initiating another COT. The operations of 720 may be performed in accordance with examples as described herein. In some implementations, aspects of the operations of 720 may be performed by a device as described with reference to FIG. 1.

In an embodiment, as described above, one or more receiving UE 104b may transmit HARQ feedback within a COT established by a transmitting UE 104a in unlicensed spectrum without initiating another COT. That is, the receiving UE 104b may transmit the HARQ feedback within the COT established by the transmitting UE without establishing a COT for itself, or a second COT.

In an embodiment, one or more receiving UE 104b transmits a Sidelink Synchronization Signal Block (S-SSB) within the COT established by the transmitting UE 104a without initiating another COT.

Synchronization information can be transmitted by a SyncRef UE 104 in sidelink to expand the synchronization coverage of a synchronization source and to enable nearby UEs to have the same sidelink timing reference. This allows sidelink communication to and from the SyncRef UE as well as sidelink communication between nearby UEs. The sidelink synchronization information may be carried in a Sidelink Synchronization Signal Block (S-SSB) with Physical Sidelink Broadcast Channel (PSBCH), Sidelink Primary Synchronization Signal (S-PSS) and Sidelink Secondary Synchronization Signal (S-SSS) symbols. The S-SSB may occupy one slot. For a normal CP or extended CP, the PSBCH, S-PSSS and S-SSS may be carried in the first 13 or 11 symbols of an S-SSB slot, respectively.

An example of a S-SSB slot for a normal CP is depicted in FIG. 6, in which the last symbol is used as a guard symbol. Since a typical S-SSB is not frequency multiplexed with any other sidelink physical channel within the sidelink bandwidth part (BWP), S-SSBs may not be transmitted in the slots of a resource pool. In the frequency domain, the S-SSB may span 11 common RBs within the sidelink BWP. Since an RB has 12 subcarriers, the SSSB bandwidth spans 11×12=132 subcarriers. The frequency location of an S-SSB is typically configured within a sidelink BWP.

In an embodiment, a sidelink UE 104 transmitting a S-SSB considers a COT acquired by some other UE 104 as being shared for the transmission of the S-SSB. For cases when the S-SSB reception by a sidelink UE 104 from a SyncRef UE falls within the COT acquired by the sidelink UE 104, the sidelink UE 104 may implicitly share the COT with the SyncRef UE for the transmission of the SL-SSB.

In such an embodiment, the sidelink UE 104 may indicate information on the acquired COT such as remaining COT duration, used CAPC for initiating the COT, etc. to the SyncRef UE 104 within SCI. The receiving UE 104b may extract that information from the SCI at 710, and determine that the COT is shared at 715 based on the extracted information.

Since COT sharing allows a shorter or no required channel sensing time for a clear channel assessment, it is beneficial for a UE 104 to consider the COT as shared for the S-SSB transmission. According to one implementation, the shared COT is only valid for the S-SSB transmission, so no further sidelink transmissions from the SyncRef UE 104 are allowed within the shared COT. In an embodiment, after the S-SSB transmission, the right to use the remaining COT is implicitly given back to the device which had originally initiated the COT (the transmitting UE 104a), such that the SyncRef UE 104 implicitly shares the remaining COT back to the sidelink UE 104.

At 725, the method may include transmitting a cyclic prefix. The operations of 725 may be performed in accordance with examples as described herein. In some implementations, aspects of the operations of 725 may be performed by a device as described with reference to FIG. 1.

In one example a receiving UE uses CP extension to shorten the gap before and/or after the PSFCH symbol. In FIG. 5, these gaps correspond to the guard intervals before and after the PSFCH symbol. Transmitting the CP at 725 may be performed when SCI information extracted at 710 indicates that HARQ is enabled for the corresponding PSSCH transmission, or for any of the conditions in which the receiving UE 104b determines that the COT established by a transmitting UE 104a is shared at 715.

At 730, the method may include transmitting a copy of at least a portion of the information transmitted in a PSFCH. The operations of 730 may be performed in accordance with examples as described herein. In some implementations, aspects of the operations of 730 may be performed by a device as described with reference to FIG. 1.

In an embodiment, a UE 104 appends an identical copy of at least a first portion of a PSFCH symbol after the PSFCH symbol. According to one implementation, the UE 104 is a sidelink receiving UE 104b which transmits a PSFCH in response to the reception of a PSSCH from a transmitting UE 104a. In order to shorten the gap between a PSFCH and the next PSCCH/PSSCH symbol or the AGC symbol before the next PSCCH symbol, the receiving UE 104b prolongs the PSFCH transmission in order to not lose the channel. Shortening the gap may obviate the need to perform LBT for the PSCCH/PSSCH transmission in the shared COT.

In one example, the identical copy of the first portion of the PSFCH symbol is used to partially or completely fill a one symbol gap. The length of the copy extension may be a single symbol duration or a single symbol duration minus 16 μs. According to an embodiment, the UE 104 is configured to extend the PSFCH as described above to shorten the gap following the PSFCH symbol. In one example an SCI scheduling a PSSCH transmission indicates whether a receiving UE 104b should extend the PSFCH transmission, for example by appending an identical copy of a first portion of the PSFCH after the PSFCH symbol. This information may be extracted from the SCI at 710.

As described above, embodiments of the present disclosure support the following novel features.

When a PSFCH symbol is in an RP overlapping with a COT acquired by a transmitting UE 104a transmitting a PSSCH, then a receiving UE 104b implicitly assumes the COT is shared by the transmitting UE 104a or the PSFCH transmission. The gap before the PSFCH symbol may be filled with CP extension to shorten the gap, and whether to use CP extension for the PSFCH transmission may be configured for the resource pool.

SCI accompanying the PSSCH indicates whether the COT is shared for PSFCH. If HARQ is enabled for PSSCH transmission, the receiving UE 104b does not initiate its own COT for the PSFCH transmission.

A new explicit field within the SCI indicates COT sharing for PSFCH. Another new explicit field within the SCI indicates using CP extension for a gap before the PSFCH.

For a sidelink transmission, the SCI indicates whether the receiving UE 104b initiates its own COT or shares the transmitting UE 104a's COT, as well as the corresponding LBT scheme (Cat-1 or Cat-2 with proper CP extension) for the PSFCH.

In one implementation, SCI-only is used to indicate COT sharing, for which no PSSCH is present.

In one implementation, SCI indicates that no LBT is performed before a PSFCH transmission.

In one implementation, a SyncRef UE 104 implicitly assumes that COT is shared for a S-SSB transmission when the S-SSB falls within an acquired COT of a UE receiving the S-SSB.

It should be noted that the methods described herein describe possible implementations, and that the operations and the steps may be rearranged or otherwise modified and that other implementations are possible. Further, aspects from two or more methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

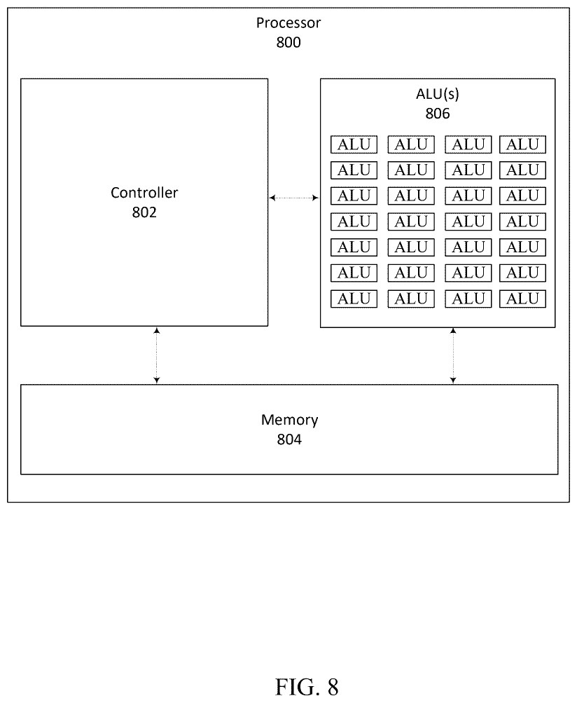

FIG. 8 illustrates an example of a processor 800 that supports channel occupancy sharing for sidelink transmissions in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, such as L1/L2/L3 cache. Additionally, or alternatively, the processor 800 may optionally include one or more arithmetic-logic units (ALUs) 800. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved.

For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementation, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, and the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 800 may be configured to support various operations in accordance with examples as described herein. In some implementations the one or more ALUs 800 may reside within or on a processor chipset (e.g., the processor 800). In some other implementations, the one or more ALUs 800 may reside external to the processor chipset (e.g., the processor 800). One or more ALUs 800 may perform one or more computations such as addition, subtraction, multiplication, and division on data. For example, one or more ALUs 800 may receive input operands and an operation code, which determines an operation to be executed. One or more ALUs 800 be configured with a variety of logical and arithmetic circuits, including adders, subtractors, shifters, and logic gates, to process and manipulate the data according to the operation. Additionally, or alternatively, the one or more ALUs 800 may support logical operations such as AND, OR, exclusive-OR (XOR), not-OR (NOR), and not-AND (NAND), enabling the one or more ALUs 800 to handle conditional operations, comparisons, and bitwise operations.

The processor 800 may support wireless communication in accordance with examples as disclosed herein. The processor 800 may be configured to or operable to support a means for channel occupancy sharing for sidelink transmissions.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1.-20. (canceled)

21. A user equipment (UE) for wireless communication, comprising:
at least one memory; and
at least one processor coupled with the at least one memory and configured to cause the UE to:
receive sidelink control information (SCI) indicating sidelink resources for a physical sidelink shared channel (PSSCH) transmission, the SCI including a field indicating a channel occupancy time (COT) duration; and
transmit hybrid automatic repeat request (HARQ) feedback within the COT duration in a physical sidelink feedback channel (PSFCH) transmission without initiating another COT based on the SCI.

22. The UE of claim 21, wherein the at least one processor is further configured to cause the UE to extract the COT duration from the SCI, and
transmit the HARQ feedback without initiating another COT when the PSFCH transmission falls within the COT duration extracted from the SCI.

23. The UE of claim 21, wherein the at least one processor is configured to cause the UE to determine the COT duration indicated by the SCI as shared for the transmission of the HARQ feedback on the PSFCH.

24. The UE of claim 21, wherein the at least one processor is further configured to cause the UE to determine whether to initiate another COT before transmitting the HARQ feedback based on an information field within the SCI.

25. The UE of claim 24, wherein the information field indicates whether HARQ is enabled for the PSSCH transmission.

26. The UE of claim 25, wherein the at least one processor is further configured to cause the UE to determine not to initiate another COT before transmitting the HARQ feedback after confirming 1) the SCI indicates that HARQ is enabled for the PSSCH transmission, and 2) the PSFCH transmission is within the COT duration indicated by the SCI.

27. The UE of claim 21, wherein the HARQ feedback is sent for the PSSCH transmission.

28. The UE of claim 21, wherein the at least one processor is further configured to cause the UE to transmit a Sidelink Synchronization Signal Block (S-SSB) within the COT without initiating another COT.

29. The UE of claim 28, wherein the at least one processor is further configured to cause the UE to determine the COT duration indicated by the SCI as shared for the transmission of the S-SSB.

30. The UE of claim 21, wherein the at least one processor is further configured to cause the UE to:
transmit an identical copy of at least a first portion of the PSFCH transmission immediately after transmitting the HARQ feedback on the PSFCH.

31. The UE of claim 21, wherein the only transmissions permitted by the UE during the COT indicated by the SCI comprise the HARQ feedback and a repeat of the HARQ feedback.

32. A method performed by a user equipment (UE), the method comprising:
receiving sidelink control information (SCI) indicating sidelink resources for a physical sidelink shared channel (PSSCH) transmission, the SCI including a field indicating a channel occupancy time (COT) duration of a first COT; and
transmitting hybrid automatic repeat request (HARQ) feedback in a physical sidelink feedback channel (PSFCH) transmission within the COT duration without initiating another COT based on the SCI.

33. The method of claim 32, further comprising:
extracting the COT duration from the SCI; and
transmitting the HARQ feedback without initiating another COT when the PSFCH transmission falls within the COT duration extracted from the SCI.

34. The method of claim 32, further comprising:
determining the COT duration indicated by the SCI as shared for the transmission of the HARQ feedback on the PSFCH.

35. The UE of claim 32, further comprising:
determining whether to initiate another COT before transmitting the HARQ feedback based on an information field within the SCI.

36. The method of claim 35, wherein the information field indicates whether HARQ is enabled for the PSSCH transmission.

37. The method of claim 36, further comprising:
determining not to initiate another COT before transmitting the HARQ feedback after confirming 1) the SCI indicates that HARQ is enabled for the PSSCH transmission, and 2) the PSFCH transmission is within the COT duration indicated by the SCI.

38. The UE of claim 32, further comprising:
transmitting a Sidelink Synchronization Signal Block (S-SSB) within the COT.

39. The method of claim 38, further comprising:
determining the COT duration indicated by the SCI as shared for the transmission of the S-SSB.

40. A processor for wireless communication, comprising:
at least one memory; and
a controller coupled with the at least one memory and configured to cause the controller to:
receive sidelink control information (SCI) indicating sidelink resources for a physical sidelink shared channel (PSSCH) transmission, the SCI including a field indicating a channel occupancy time (COT) duration; and
transmit hybrid automatic repeat request (HARQ) feedback within the COT duration in a physical sidelink feedback channel (PSFCH) transmission without initiating another COT based on the SCI.
